(19) United States
(12) Patent Application Publication
(10) Pub. No.: US 2012/0212573 A1
(43) Pub. Date: Aug. 23, 2012

(54) METHOD, TERMINAL AND COMPUTER-READABLE RECORDING MEDIUM FOR GENERATING PANORAMIC IMAGES

(75) Inventor: Bong Cheol Park, Seoul (KR)

(73) Assignee: OLAWORKS, INC., Seoul (KR)

(21) Appl. No.: 13/298,549

(22) Filed: Nov. 17, 2011

(30) Foreign Application Priority Data
Feb. 21, 2011 (KR) 10-2011-0015125

(51) Int. Cl. H04N 7/00

(52) U.S. Cl. 348/36; 348/E07.085

(57) ABSTRACT

The present invention relates to a method for generating a panoramic image. The method includes the steps of: (a) adjusting resolutions of a first and a second input images, respectively, to thereby generate a first and a second adjusted images, wherein the resolutions of the first and the second adjusted images are determined by referring to pre-fixed relationship data with respect to the resolutions of the adjusted images to those of the input images; (b) generating a first and a second pre-processed images which represent information on edges of the first and the second adjusted images by referring to tangent vector components vertical to gradient vector components; and (c) performing image matching operations between the first and the second pre-processed images and then determining an optimal overlapped position where the first and the second input images are synthesized by referring to results of the image matching operations.

### CROSS-REFERENCE TO RELATED APPLICATION

This application claims priority to and incorporates herein by reference all disclosure in Korean Patent Application No. 10-2011-0015125 filed Feb. 21, 2011.

### TECHNICAL FIELD

The present invention relates to a method, a terminal and a computer-readable recording medium for generating a panoramic image; and more particularly, to the method, the terminal and the computer-readable recording medium for performing (i) a process for adjusting a resolution, i.e., a process for reducing a resolution, of an image serving as a subject for image matching operations step by step by using a pyramidal structure and (ii) a pre-processing process which visually expresses edges in the image with tangent vector components vertical to the gradient vector components representing the change in intensity or color, to thereby improve accuracy and operation speed of generating the panoramic image.

### BACKGROUND OF THE INVENTION

Recently as digital cameras have been popular and digital processing technologies have been developed, a variety of services using an image including complete views viewed from a random point, so-called a panoramic image, have been introduced.

For an example of the service using panoramic images, a service for supporting users to acquire panoramic images by automatically synthesizing multiple images taken consecutively in the use of portable terminals which have photographic equipments with a relatively narrow angle of view was also introduced.

Generally, panoramic images are created by putting boundaries of multiple consecutive images together and synthesizing them. Therefore, the quality of the panoramic images depends on how accurately the boundaries of adjacent images are put together. According to a conventional technology for generating panoramic image, a panoramic image is created by synthesizing the original copies of photographed images as they are or synthesizing the original copies of photographed images from which just noise is removed.

According to the conventional technology, the contours of important objects such as buildings included in the original image and those of meaningless objects such as dirt, however, may not be divided clearly and this may cause the synthesis of images to be less accurate. Further, since the original image contains many features to be considered when the boundaries of the adjacent images are matched, it may cause a great number of operations to be required to generate the panoramic image. These problems may be more serious in a mobile environment where portable user terminals with relatively poor operational capabilities are used.

Therefore, the applicant of the present invention came to invent a technology for effectively generating panoramic images even in a mobile environment by applying a method for adjusting a resolution of an image step by step and a method for simplifying the image by emphasizing only important part(s) of the image, i.e., so-called a method for characterizing the image.

### SUMMARY OF THE INVENTION

It is an object of the present invention to solve all the problems mentioned above.

It is another object of the present invention to gradually reduce the resolution of a subject image and diminish operations required for image matching by using image pyramid technology, to thereby generate a panoramic image.

It is still another object of the present invention to emphasize important part(s) of the image for the simplification thereof by performing a pre-processing process that expresses edges of images to be used for image matching by referring to tangent vector components vertical to gradient vector components which show changes in intensity or color in the image.

In accordance with one aspect of the present invention, there is provided a method for generating a panoramic image including the steps of: (a) adjusting resolutions of a first and a second input images, respectively, to thereby generate a first and a second adjusted images, wherein the resolutions of the first and the second adjusted images are determined by referring to pre-fixed relationship data with respect to the resolutions of the adjusted images to those of the input images; (b) generating a first and a second pre-processed images which represent information on edges of the first and the second adjusted images by referring to tangent vector components vertical to gradient vector components showing changes in intensity or color of the first and the second adjusted images, respectively; and (c) performing image matching operations between the first and the second pre-processed images and then determining an optimal overlapped position where the first and the second input images are synthesized by referring to results of the image matching operations.

In accordance with another aspect of the present invention, there is provided a user terminal for generating a panoramic image including: a resolution adjusting part for adjusting resolutions for a first and a second input images, respectively, to thereby generate a first and a second adjusted images, wherein the resolutions of the first and the second adjusted images are determined by referring to pre-fixed relationship data with respect to the resolutions of the adjusted images to those of the input images; a pre-processing part for generating a first and a second pre-processed images which represent information on edges of the first and the second adjusted images by referring to tangent vector components vertical to gradient vector components showing changes in intensity or color of the first and the second adjusted images, respectively; and a matching part for performing image matching operations between the first and the second pre-processed images and then determining an optimal overlapped position where the first and the second input images are synthesized by referring to results of the image matching operations.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram exemplarily presenting an internal configuration of a user terminal 100 in accordance with one example embodiment of the present invention.

FIG. 2 is a drawing visually illustrating a result of calculating gradient vector components in an image in accordance with one example embodiment of the present invention.

FIG. 3 is a diagram visually showing a result of calculating tangent vector components in an image in accordance with one example embodiment of the present invention.

FIGS. 4A and 4B are diagrams exemplarily illustrating an original image and its pre-processed image respectively in accordance with one example embodiment of the present invention.

FIGS. 5A and 5B are diagrams exemplarily illustrating an original image and its pre-processed image respectively in accordance with one example embodiment of the present invention.

FIGS. 6A and 6B are drawings which exemplarily illustrate results of generating respective panoramic images by synthesizing two adjacent input images in accordance with one example embodiment of the present invention.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable the persons skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows:

Herein, a panoramic image means an image acquired as a result of photographing a complete view viewed from a point and more particularly, a type of the image capable of offering visual information on all directions actually shown at a shooting point three-dimensionally and realistically by expressing pixels constructing the image on a virtual celestial sphere whose center is the shooting point according to spherical coordinates. Further, the panoramic image may be an image expressing the pixels constructing the image according to cylindrical coordinates.

### Configuration of User Terminal

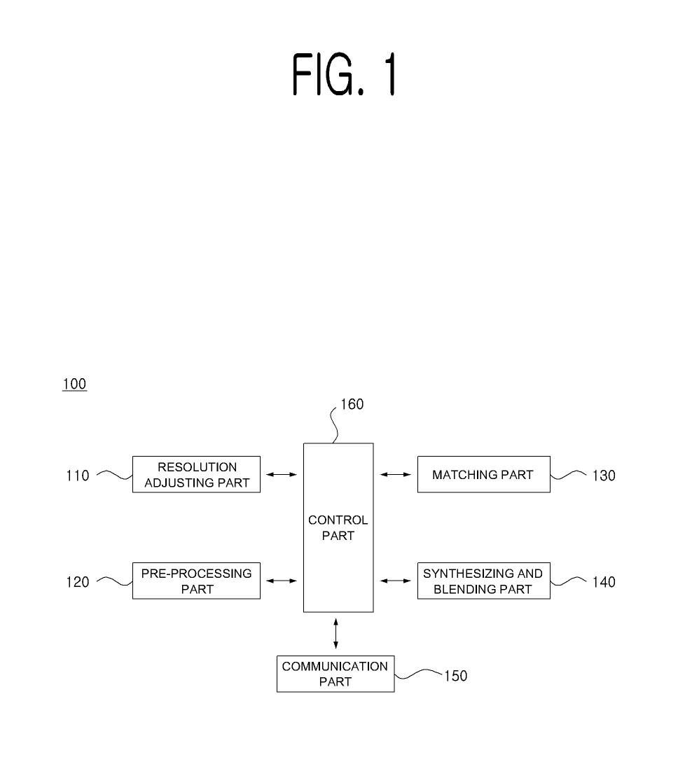

FIG. 1 is a diagram exemplarily presenting an internal configuration of a user terminal 100 in accordance with one example embodiment of the present invention.

By referring to FIG. 1, the user terminal 100 in accordance with one example embodiment of the present invention may include a resolution adjusting part 110, a pre-processing part 120, a matching part 130, a synthesizing and blending part 140, a communication part 150 and a control part 160. In accordance with one example embodiment of the present invention, at least some of the resolution adjusting part 110, the pre-processing part 120, the matching part 130, the synthesizing and blending part 140, the communication part 150 and the control part 160 may be program modules communicating with the user terminal 100. Such program modules may be included in the user terminal 100 in a form of an operating system, an application program module and other program modules, or they may be physically stored in various storage devices well known to those skilled in the art or in a remote storage device capable of communicating with the user terminal 100. The program modules may include but not be subject to a routine, a subroutine, a program, an object, a component, and a data structure for executing a specific operation or a type of specific abstract data that will be described in accordance with the present invention.

First, in accordance with one example embodiment of the present invention, the resolution adjusting part 110 may adjust resolutions of input images which are subjects of syntheses for generating a panoramic image to thereby generate the images with adjusted resolutions (the “adjusted image(s)”). Herein, the resolution of the adjusted image may be determined by referring to pre-fixed relationship data regarding the resolution of the adjusted image to that of the input image.

More specifically, the adjusting part 110 in accordance with one example embodiment of the present invention resolution may determine an optimal resolution of the adjusted image by diminishing a resolution thereof gradually according to a pyramid structure, as long as a matching rate between adjacent adjusted images in the prescribed overlapped region where the adjacent adjusted images are overlapped satisfies a threshold matching rate. Herein, the prescribed overlapped region means a region where adjacent images are overlapped when the adjacent images are placed enough to be overlapped as expected in statistics or practical experiences before image matching is performed to put multiple images together to generate a panoramic image. For instance, the prescribed overlapped region, as a region corresponding to the boundaries including top, bottom, left and right of the image, may be set to be a region accounting for 10 percent of the whole area of the image. Below is a more specific description on a process of deciding the resolution of the adjusted image in accordance with one example embodiment of the present invention.

For example, it may be assumed that adjacent input images A and B are 1920×1080 pixels with the threshold matching rate of, e.g., 80 percent and the resolutions of the adjacent images are gradually reduced by one-fourth by using the pyramid structure. In accordance with one example embodiment of the present invention, assuming that a matching rate of the first adjusted images A and B (whose resolutions become 960×540 pixels respectively thanks to reduction by one fourth) in a prescribed overlapped region reaches 84%, since the matching rate of the first adjusted images A and B satisfies the threshold matching rate, it may be possible to temporarily determine the resolutions of the fist adjusted images A and B as 960×540 pixels respectively and then reduce the resolutions thereof by one fourth again respectively at a next step. At the second reduction step, if a matching rate of the second adjusted images A and B in the prescribed overlapped region whose resolutions are 480×270 pixels due to the reduction by one fourth again is 65 percent, it fails to satisfy the threshold matching rate of 80%. Therefore, the process for reducing the resolutions is suspended, and then the resolutions of the adjusted images A and B may be finally determined as 960×540 pixels which are same as the resolutions of the first adjusted images. But the process for acquiring relationship data in the present invention is not limited only to the method mentioned above and it will be able to be changed within the scope of the achievable objects of the present invention.

In accordance with one example embodiment of the present invention, the pre-processing part 120, furthermore, may perform a function for generating a pre-processed image(s) which expresses information on edges (i.e., contour) in the input image(s) whose resolution is adjusted by the resolution adjusting part 110, wherein the edges are acquired by referring to the tangent vector components vertical to the gradient vector components which represent the changes in intensity or color in the adjusted image. Below is a more detailed explanation on the pre-processing process in accordance with one example embodiment of the present invention.

First, the pre-processing part 120 in accordance with one example embodiment of the present invention may calculate the gradient vector components representing the changes in intensity or color with respect to respective pixels in the two-dimensional adjusted image. Herein, directions of the gradient vector components may be determined in the directions of maximum changes in intensity or color and magnitudes of the gradient vector components may be decided to be the rate of change in the directions of the maximum changes in intensity or color. Because magnitudes of the gradient vector components are large in some parts, such as contours of an object, where the changes in intensity or color are great and on the other hand magnitudes of the gradient vector components are small in other parts where the changes in intensity or color are small, the edges included in the adjusted image may be detected by referring to the gradient vector components. In accordance with one example embodiment of the present invention, the Sobel operator may be available to calculate the gradient vector components in the adjusted image. But it is not limited only to this and other operators for computing the gradient vector components to detect edges in the adjusted image may be also applied.

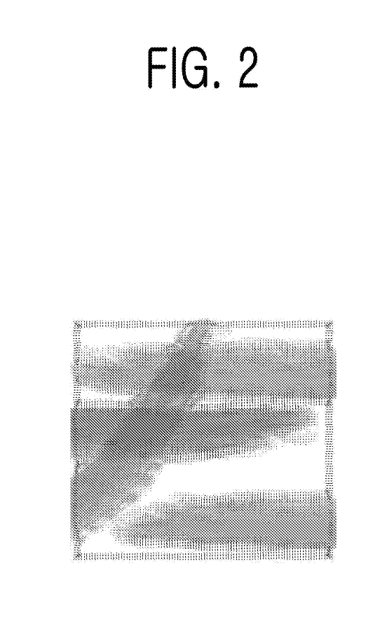

FIG. 2 is a drawing visually illustrating a result of calculating gradient vector components in an image in accordance with one example embodiment of the present invention.

By referring to FIG. 2, the directions and the magnitudes of the gradient vector components are expressed by many fine lines. It may be found that a length of a fine line appears long in a part where a change in intensity or color is great while a length of a fine line is short or does not appear at all in a part where a change in intensity or color is small.

Herein, the pre-processing part 120 in accordance with one example embodiment of the present invention may perform a function of calculating tangent vector components by rotating the calculated gradient vector components for respective pixels of the two-dimensional adjusted image 90 degrees counterclockwise. Since the calculated tangent vector components are parallel to virtual outlines drawn based on the magnitudes of intensity or color, the visually expressed tangent vector components may be the shapes same as those along the edges of the contour, etc. of the object included in the adjusted image. Accordingly, the pre-processed image which visually illustrates the tangent vector components in the adjusted image may play a role itself as an edge image by emphasizing only the edges included in the adjusted image.

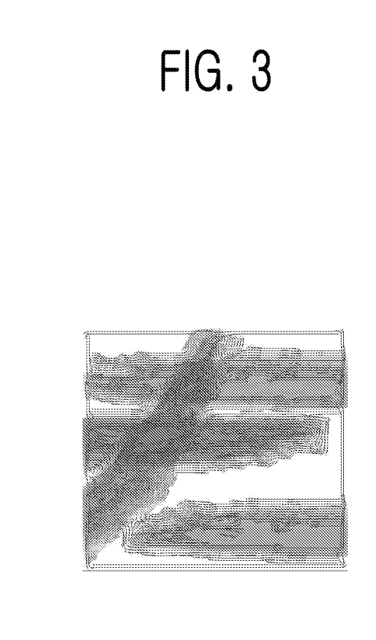

FIG. 3 is a diagram visually showing a result of calculating tangent vector components in an image in accordance with one example embodiment of the present invention.

By referring to FIG. 3, it may be found that the tangent vector components whose directions and magnitudes are expressed by fine lines are parallel along parts whose changes in intensity or color in the image are great, i.e., edges.

As an example of a technology available to compute tangent vector components in an image, it is possible to refer to an article titled “Coherent Line Drawing” co-authored by H. Kang and two others and published in 2007 on “ACM Symposium on Non-Photorealistic Animation and Rendering” (The whole content of the article must be considered to have been combined herein). The article describes a method for calculating edge tangent flow (ETF) in an image as a step of automatically illustrating lines corresponding to the contours included in the image. Of course, the technology for calculating the tangent vector components applicable to the present invention is not limited only to the method described in the aforementioned article and it will be able to reproduce the present invention by applying various examples.

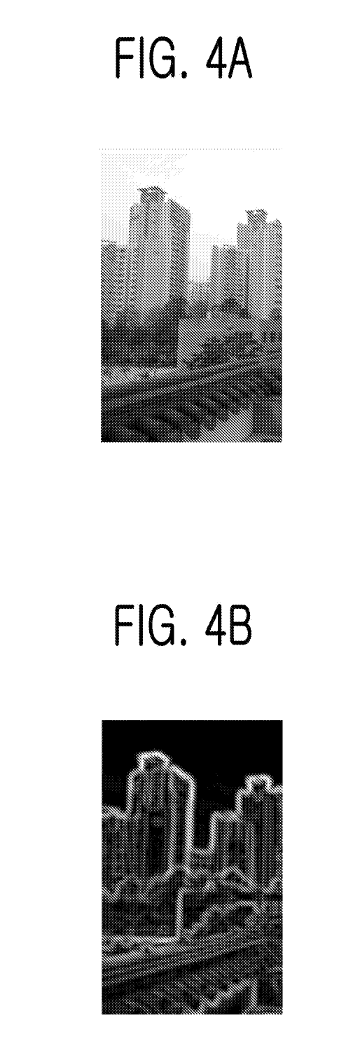

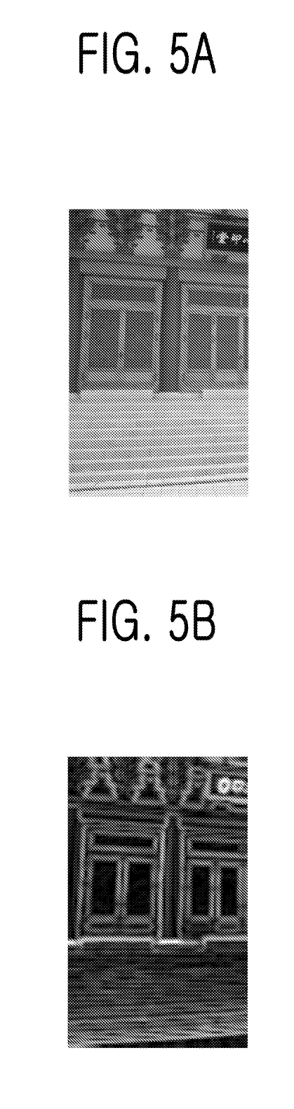

On FIGS. 2 and 3, while the lines for parts where the changes in intensity or color are great are long, those for parts where the changes in intensity or color are small are short but it is not limited only to this. As shown in FIGS. 4 and 5, it will be able to reproduce the present invention by applying various examples. That is, pixels are expressed more brightly as the magnitudes of tangent vector components are large and on the other hand pixels are expressed more darkly as the magnitudes of the tangent vector components are small.

FIGS. 4A and 4B are diagrams exemplarily illustrating an original image and its pre-processed image respectively in accordance with one example embodiment of the present invention.

FIGS. 5A and 5B are diagrams exemplarily illustrating an original image and its pre-processed image respectively in accordance with one example embodiment of the present invention.

By reference, the pre-processed images in FIG. 4B and 5B are the images whose pixels are expressed brightly if the magnitudes of the tangent vector components are large.

By referring to FIGS. 4 and 5, in comparison with the original input images (FIGS. 4A and 5A), the pre-processed images (FIGS. 4B and 5B) may be confirmed that the original input images are featured and simplified by emphasizing important parts including contours of the object and boldly omitting unimportant parts.

The use of the pre-processed image, which is acquired as a result of performing a process of reducing the resolution of the original input image to a reasonable level and then a pre-processing process to visually express the edges with the tangent vector components for the adjusted image as shown above, as an image for matching process to be explained below may achieve an effect of improving accuracy of image matching and increasing the operational speed of image matching at the same time.

In accordance with one example embodiment of the present invention, the matching part 130, furthermore, may perform image matching operations between adjacent pre-processed images which are generated by the pre-processing part 120 and carry out a function of determining an optimal overlapped position between the original input images corresponding to the pre-processed images by referring to results of the image matching operations. For example, the matching part 130 in accordance with one example embodiment of the present invention may perform the image matching operations at the aforementioned prescribed overlapped region first.

In accordance with one example embodiment of the present invention, the synthesizing and blending part 140, additionally, may synthesize the adjacent input images by referring to the optimal overlapped position determined by the matching part 130 and perform a blending process to make connected portion in the synthesized input images look natural.

As an example of a technology available for matching, synthesizing and blending images, an article titled “Panoramic Imaging System for Camera Phones” co-authored by Karl Pulli and four others and published in 2010 in “International Conference on Consumer Electronics” may be referred to (The whole content of the article may be considered to have been combined herein). The article descries a method for performing image matching between adjacent images by using feature-based matching technology combined with RANSAC (RANdom SAmple Consensus) and a method for processing connected portion of the adjacent images softly by using alpha blending technology. Of course, the synthesis and blending technologies applicable for the present invention is not limited only to the method described in the aforementioned article and it will be able to reproduce the present invention by applying various examples.

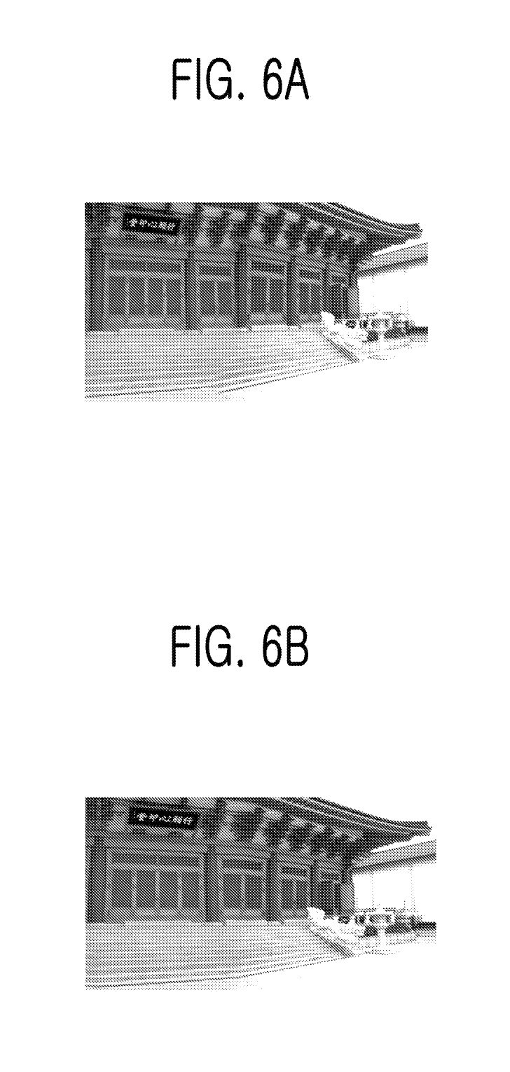

FIGS. 6A and 6B are drawings which exemplarily illustrate results of generating respective panoramic images by synthesizing two adjacent input images in accordance with one example embodiment of the present invention.

By reference, panoramic images illustrated in FIGS. 6A and 6B may be acquired as a result of synthesizing two taken input images of a traditional styled building viewed from different angles. FIG. 6A is a drawing representing a result of generating a panoramic image without going through the step of adjusting a resolution of the input images and then the step of pre-processing the input images, while FIG. 6B is a drawing showing a result of generating a panoramic image through the step of adjusting a resolution of the input images and then the step of pre-processing the input images in accordance with one example embodiment of the present invention.

By referring to FIGS. 6A and 6B, the panoramic image on FIG. 6B in accordance with the present invention may be confirmed to be generated more accurately and more naturally than the existing panoramic image in FIG. 6A and particularly, it may be confirmed that there are big differences between the part of the stairs and the part of pillars located on the right of the signboard.

The communication part 150 in accordance with one example embodiment of the present invention may perform a function of allowing the user terminal 100 to communicate with an external device (not illustrated).

The control part 160 in accordance with one example embodiment of the present invention may perform a function of controlling data flow among the resolution adjusting part 110, the pre-processing part 120, the matching part 130, the synthesizing and blending part 140 and the communication part 150. In other words, the control part 160 may control the flow of data from outside or among the components of the user terminal 100 to thereby force the resolution adjusting part 110, the pre-processing part 120, the matching part 130, the synthesizing and blending part 140 and the communication part 150 to perform their unique functions.

Since it is possible to reduce operations required for image matching by reducing the resolutions of the images in accordance with the present invention, an effect of reducing the time required for generating a panoramic image will be achieved.

For the reason that it may be possible to specify and simplify an image which is a subject of image matching by expressing the edges in the image with the tangent vector components vertical to the gradient vector components representing changes in intensity or color in accordance with the present invention, an effect of improving operational speed while securing accuracy of synthesizing the panoramic image is achieved.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for generating a panoramic image comprising the steps of:
(a) adjusting resolutions of a first and a second input images, respectively, to thereby generate a first and a second adjusted images, wherein the resolutions of the first and the second adjusted images are determined by referring to pre-fixed relationship data with respect to the resolutions of the adjusted images to those of the input images;
(b) generating a first and a second pre-processed images which represent information on edges of the first and the second adjusted images by referring to tangent vector components vertical to gradient vector components showing changes in intensity or color of the first and the second adjusted images, respectively; and
(c) performing image matching operations between the first and the second pre-processed images and then determining an optimal overlapped position where the first and the second input images are synthesized by referring to results of the image matching operations.

2. The method of claim 1 further comprising the step of: (d) generating a panoramic image by synthesizing and blending the first and the second input images at the optimal overlapped position.

3. The method of claim 1 wherein, at the step of (a), the resolutions of the first and the second adjusted images are determined within a scope of a matching rate between the first and the second adjusted images satisfying the predetermined level in a region where the two images are overlapped.

4. The method of claim 1 wherein the gradient vector components are calculated by a Sobel operator.

5. The method of claim 1 wherein the tangent vector components are vectors rotating the gradient vector components 90 degrees counterclockwise.

6. The method of claim 1 wherein the image matching operations between the first and the second pre-processed images are performed by using a feature-based matching technology combined with RANSAC (RANdom SAmple Consensus).

7. The method of claim 2 wherein the blending is performed by using an alpha blending technology.

8. A user terminal for generating a panoramic image comprising:
a resolution adjusting part for adjusting resolutions for a first and a second input images, respectively, to thereby generate a first and a second adjusted images, wherein the resolutions of the first and the second adjusted images are determined by referring to pre-fixed relationship data with respect to the resolutions of the adjusted images to those of the input images;
a pre-processing part for generating a first and a second pre-processed images which represent information on edges of the first and the second adjusted images by referring to tangent vector components vertical to gradient vector components showing changes in intensity or color of the first and the second adjusted images, respectively; and
a matching part for performing image matching operations between the first and the second pre-processed images and then determining an optimal overlapped position where the first and the second input images are synthesized by referring to results of the image matching operations.

9. The terminal of claim 8 further comprising a synthesizing and blending part for generating a panoramic image by synthesizing and blending the first and the second input images at the optimal overlapped position.

10. The terminal of claim 8 wherein the resolutions of the first and the second adjusted images are determined within a scope of a matching rate between the first and the second adjusted images satisfying the predetermined level in a region where the two images are overlapped.

11. The terminal of claim 8 wherein the gradient vector components are calculated by a Sobel operator.

12. The terminal of claim 8 wherein the tangent vector components are vectors rotating the gradient vector components 90 degrees counterclockwise.

13. The terminal of claim 8 wherein the matching part performs the image matching operations between the first and the second pre-processed images by using a feature-based matching technology combined with RANSAC (RANdom SAmple Consensus).

14. The terminal of claim 9 wherein the synthesizing and blending part performs the blending process by using an alpha blending technology.

15. One or more computer-readable recording media having stored thereon a computer program that, when executed by one or more processors, causes the one or more processors to perform acts including:
adjusting resolutions of a first and a second input images, respectively, to thereby generate a first and a second adjusted images, wherein the resolutions of the first and the second adjusted images are determined by referring to pre-fixed relationship data with respect to the resolutions of the adjusted images to those of the input images;
generating a first and a second pre-processed images which represent information on edges of the first and the second adjusted images by referring to tangent vector components vertical to gradient vector components showing changes in intensity or color of the first and the second adjusted images, respectively; and
performing image matching operations between the first and the second pre-processed images and then determining an optimal overlapped position where the first and the second input images are synthesized by referring to results of the image matching operations.
